(19) United States
(12) Patent Application Publication
(10) Pub. No.: US 2023/0348126 A1
(43) Pub. Date: Nov. 2, 2023

(54) A BOX ERECTING METHOD AND SYSTEM

(71) Applicant: PACKSIZE LLC, Salt Lake City, UT (US)

(72) Inventor: Niklas Pettersson, Västerås (SE)

(21) Appl. No.: 18/350,493

(22) Filed: Jul. 11, 2023

Related U.S. Application Data
(63) Continuation of application No. 17/586,517, filed on Jan. 27, 2022, now Pat. No. 11,738,897.
Application No. 17/586,517 is a division of application No. 16/491,088, filed on Sep. 4, 2019, now Pat. No. 11,286,073.

(30) Foreign Application Priority Data
Mar. 6, 2017 (SE) 1750247-7

(51) Int. Cl. B31B 50/00; B65B 43/26; B31B 50/36; B31B 50/62; B31B 50/26; B65B 11/00; B65B 59/00

(52) U.S. Cl. CPC B65B 43/265; B31B 50/004; B31B 50/006; B31B 50/262; B31B 50/36; B31B 50/624; B65B 11/004; B65B 59/003; B31B 2120/302

(57) ABSTRACT

A method and a system for erecting boxes from box templates of different sizes, said method comprising the steps of:
adjusting a size of a frame according to a size of a box template which should be erected;
wrapping the box template to be erected around the frame; and
separating the frame from the box template.

### CROSS-REFERENCE TO RELATED APPLICATIONS

The present application is a continuation of U.S. Application No. 17/586,517, filed Jan. 27, 2022, and entitled A Box Erecting Method and System, which is a divisional of U.S. Application No. 16/491,088, filed Sep. 4, 2019, and entitled A Box Erecting Method and System, now U.S. Pat. No. 11,286,073, issued on Mar. 29, 2022, which claims priority to PCT Application No. PCT/US2018/020928, filed Mar. 5, 2018, and entitled A BOX ERECTING METHOD AND SYSTEM, which claims the benefit of and priority to Sweden Application No. 1750247-7, filed Mar. 6, 2017. All of the aforementioned applications are incorporated by reference herein in their entireties.

### BACKGROUND

### Technical Field

The present invention relates to a box erecting method and system and to a box production method and system.

### Related Art

Erecting boxes from box templates in for example shipping and packaging industries can be done manually and/or with help from some erecting tools. These tools could for example comprise vacuum tools for gripping certain parts of a box template while folding other parts, such as for example a bottom of the box. Automatic erecting of boxes may encounter problems for example when different sizes of boxes should be erected with use of the same tools and/or if the box walls are not as stable as required, for example due to folds provided in the templates due to a fanfold storage of the template material.

Shipping and packaging industries frequently use cardboard and other sheet material processing equipment that converts sheet materials into box templates. One advantage of such equipment is that a shipper may prepare boxes of required sizes as needed in lieu of keeping a stock of standard, pre-made boxes of various sizes. Consequently, the shipper can eliminate the need to forecast its requirements for particular box sizes as well as to store pre-made boxes of standard sizes. Instead, the shipper may store one or more bales of fanfold material, which can be used to generate a variety of box sizes based on the specific box size requirements at the time of each shipment. This allows the shipper to reduce storage space normally required for periodically used shipping supplies as well as reduce the waste and costs associated with the inherently inaccurate process of forecasting box size requirements, as the items shipped and their respective dimensions vary from time to time.

In addition to reducing the inefficiencies associated with storing pre-made boxes of numerous sizes, creating custom sized boxes also reduces packaging and shipping costs. In the fulfillment industry it is estimated that shipped items are typically packaged in boxes that are about 65% larger than the shipped items. Boxes that are too large for a particular item are more expensive than a box that is custom sized for the item due to the cost of the excess material used to make the larger box. When an item is packaged in an oversized box, filling material (e.g., Styrofoam, foam peanuts, paper, air pillows, etc.) is often placed in the box to prevent the item from moving inside the box and to prevent the box from caving in when pressure is applied (e.g., when boxes are taped closed or stacked). These filling materials further increase the cost associated with packing an item in an oversized box.

Customized sized boxes also reduce the shipping costs associated with shipping items compared to shipping the items in oversized boxes. A shipping vehicle filled with boxes that are 65% larger than the packaged items is much less cost efficient to operate than a shipping vehicle filled with boxes that are custom sized to fit the packaged items. In other words, a shipping vehicle filled with custom sized packages can carry a significantly larger number of packages, which can reduce the number of shipping vehicles required to ship the same number of items. Accordingly, in addition or as an alternative to calculating shipping prices based on the weight of a package, shipping prices are often affected by the size of the shipped package. Thus, reducing the size of an item’s package can reduce the price of shipping the item. Even when shipping prices are not calculated based on the size of the packages (e.g., only on the weight of the packages), using custom sized packages can reduce the shipping costs because the smaller, custom sized packages will weigh less than oversized packages due to using less packaging and filling material.

A typical box template production system includes a converting part that cuts, scores, and/or creases sheet material to form a box template. The sheet material can be provided to the system from fanfolded bales. The fanfold storage of the sheet material provides unwanted fanfold folds to the box templates. These folds could be a problem when erecting the boxes, especially if tools for automatic erection are used.

### BRIEF SUMMARY

It is an object of the present invention to provide an improved method and system for erecting boxes.

It is a further object of the invention to provide a method and a system for erecting boxes which is automated and flexible.

This is achieved in a method and a system for erecting boxes according to the independent claims.

In one aspect of the invention a method for erecting boxes from box templates of different sizes is provided. Said method comprises the steps of:
adjusting a size of a frame according to a size of a box template which should be erected;
wrapping the box template to be erected around the frame; and
separating the frame from the box template.

In another aspect of the invention a box erecting system for erecting boxes from box templates of different sizes is provided. Said box erecting system comprises:
a frame comprising adjustable parts defining a size of the frame; and
a control system connected to said frame and configured for:
   i. adjusting a size of the frame by adjusting said adjustable parts according to a size of a box template which should be erected; and
   ii. wrapping the box template to be erected around the frame.

Hereby, thanks to the size adjustable frame, box templates of different sizes can be erected by the same tool. Furthermore, by wrapping the box template around a frame a stability is provided to the wrapped box template. The box template is wrapped around the frame before a manufacturer’s joint is sealed and hereby both the sealing of the manufacturer’s joint and further folding for example of a bottom of the box can be provided efficiently. A frame inside the wrapped box template provides stability to the box irrespective of the robustness of each side wall. Hereby also box templates comprising folds from fanfold storage can be erected with less manual steps required.

A further object of the invention is to provide an improved method and a system for producing boxes.

This is achieved by a method for producing boxes from sheet material, said method comprising the steps of:
producing box templates of different sizes from sheet material;
erecting the box templates according to the method for erecting boxes as described above.

This is also achieved by a box production system comprising:
at least one inlet for receiving sheet material;
at least one converter part configured for receiving said sheet material and convert said sheet material into box templates of different sizes according to given instructions;
at least one box erecting system as described above configured for erecting box templates provided from the at least one converter part.

Hereby boxes can be produced efficiently in different sizes. An automatic or partly automatic erection of the boxes can be provided close to a box template production system. In one embodiment of the invention the method further comprises a step of sealing a manufacturer’s joint of the box template and/or folding and possibly sealing a bottom of the box template before separating the frame from the box template. Hereby the stability from the frame is utilized also for these steps.

In one embodiment of the invention the step of folding a bottom of the box template comprises pushing two second opposing bottom flaps of the box template outwards from each other by at least two extendable pushing arms connected to the frame at least during an initial part of a folding of two first opposing bottom flaps of the box template for forming a bottom of the box and retracting said extendable pushing arms before folding said two second opposing bottom flaps for forming a bottom of the box. Hereby possible problems related to bottom flaps hindering each other from correct folding can be dealt with. This may be a problem especially when thin knife cutting is used for cutting the box templates instead of punching.

In one embodiment of the invention said step of wrapping comprises:
attaching a box template to be erected to the frame;
controlling the position of the frame by a control system connected to the frame such that the box template is wrapped around the frame.

In one embodiment of the invention the step of attaching the box template to the frame comprises attaching a first end of the box template to one of four corner posts provided in the frame. Hereby in one embodiment of the invention the adjustable parts of the frame comprise four corner posts and the control system is configured for controlling the position of said corner posts for different box sizes to be erected. Furthermore, in one embodiment of the invention at least one of the corner posts comprises an attachment device to which a first end of a box template can be attached during wrapping of the box template around the frame.

In one embodiment of the invention the controlling of the position of the frame comprises rotating the frame for wrapping the box template around the frame.

In one embodiment of the invention the step of sealing the manufacturer’s joint comprising providing glue to a part of the box template which will be a part of the manufacturer’s joint before the box template has been completely wrapped around the frame and thereafter complete the wrapping of the box template around the frame such that the manufacturer’s joint is sealed. In one embodiment of the invention the step of sealing the manufacturer’s joint further comprises controlling the position of the frame by a control system connected to the frame such that the box template is passing a sealing device before the box template is completely wrapped around the frame, said sealing device being connected to and controlled by the control system to eject glue to the box template for sealing the manufacturer’s joint when the box template is passing.

In one embodiment of the invention the step of wrapping the box template around the frame comprises positioning a distant end of the frame in line with bottom flap creases of the box template such that a bottom can be folded while keeping the frame inside the wrapped box template.

### BRIEF DESCRIPTION OF THE DRAWINGS

FIGS. 1a-1d show schematically a box erecting system according to one embodiment of the invention in four different positions.

FIGS. 2a-2d show schematically a box erecting system according to another embodiment of the invention in four different positions.

FIGS. 3a-3d show schematically a box erecting system according to still another embodiment of the invention in four different positions.

FIG. 4 shows a box erecting system according to one embodiment of the invention in a position where a box template is about to be wrapped around a frame of the box erecting system.

FIG. 5 shows the same box erecting system as shown in FIG. 4 in a position where a box template has been almost wrapped around the frame.

FIG. 6 shows the same box erecting system as shown in FIG. 4 in a position where the almost wrapped box template is controlled to pass in front of a sealing device for sealing of a manufacturer’s joint.

FIG. 7a shows the same box erecting system as shown in FIG. 4 in a position where minor flaps of a bottom of the box template are folded.

FIG. 7b shows one embodiment of a box erecting system in the same position as shown in FIG. 7a but from another view.

FIG. 7c shows the same embodiment as shown in FIG. 7b in a different view but in the same position.

FIG. 8 shows the same box erecting system as shown in FIG. 4 in a position where the whole bottom has been folded and the frame is about to be removed from the erected box.

FIG. 9 shows a box erecting system according to another embodiment of the invention in a position where a box template is provided beneath a frame of the box erecting system.

FIG. 10 shows the same box erecting system as shown in FIG. 9 in a position where the box template has been wrapped around the frame.

### DETAILED DESCRIPTION

According to the invention a box erecting system and a method for erecting boxes from box templates of different sizes are provided. Referring to all the embodiments of the invention and all the drawings the method comprises in its broadest sense the steps of:
adjusting a size of a frame 5; 105 according to a size of a box template 3, 103 which should be erected;
wrapping the box template to be erected around the frame; and
separating the frame from the box template.

Likewise, in its broadest sense the box erecting system 1; 101 according to the invention comprises:
a frame 5; 105 comprising adjustable parts 7; 107 defining a size of the frame; and
a control system 11; 111 connected to said frame 5; 105 and configured for:
   o adjusting a size of the frame 5; 105 by adjusting said adjustable parts 7; 107 according to a size of a box template which should be erected; and
   o wrapping the box template to be erected around the frame 5; 105.

The method and system according to the invention can be applied for different types of boxes, for example a so called Regular Slotted Container, RSC, also called Fefco 201 or American box or a Half Slotted Container HSC, also called Fefco 200.

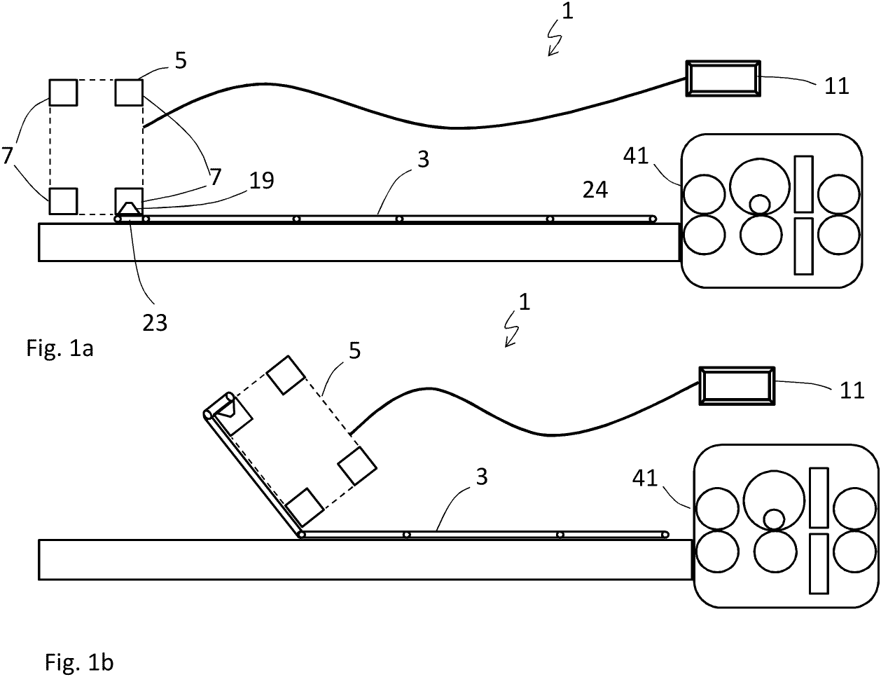

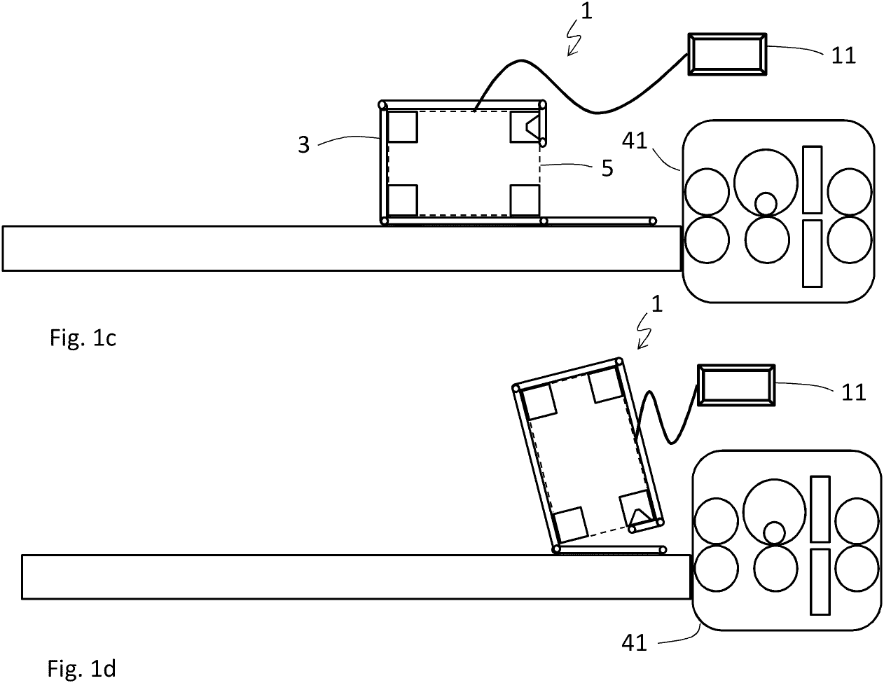

FIGS. 1a-1d show schematically a box erecting system 1 according to one embodiment of the invention in four different positions. The box erecting system 1 comprises a frame 5 and a control system 11 connected to said frame 5. The frame 5 comprises adjustable parts 7, which are defining the size of the frame 5. In this embodiment of the invention the adjustable parts 7 comprises four corner posts 7 and the control system 11 is configured for controlling the position of said corner posts 7 in accordance with different box template sizes, i.e. in accordance with different box sizes to be erected. The four corner posts 7 are positioned to form a rectangular shape corresponding to a rectangular shape of the box to be erected. Each corner post 7 will in one embodiment of the invention be provided in a corner between two side walls of the erected box. An adjustment of the size of the frame can in one embodiment of the invention be to adjust the distances between the corner posts which distances corresponds to a width and a length of the box to be erected. In this embodiment of the invention at least one of the corner posts 7 comprises an attachment device 19 to which a first end 23 of a box template 3 can be attached during wrapping of the box template around the frame 5. This could for example be a suction cup or a clamp which can be controlled from the control system 11. In the embodiment shown in FIGS. 1a-1d a first end 23 of the box template is a glue tab provided for forming part of a manufacturer’s joint. However, in another embodiment of the invention an overlap manufacturer’s joint is not necessary but instead an edge to edge manufacturer’s joint using tape sealing could be provided. In that case a first end 23 of the box template which is attached to one of the corner posts 7 is not a glue tab but simply the outermost end of the box template.

In this embodiment of the invention the control system 11 is configured for controlling the position of the frame 5 for wrapping the box template 3 around the frame 5. The control system 11 can control the attaching device 19 provided to at least one of the corner posts 7 to attach to a first end 23 of a box template 3 to be erected. The control system 11 is further in this embodiment configured to both rotate the frame 5 for wrapping the box template 3 around the frame 5 and transfer the frame along a box template extension. In the FIGS. 1a-1d it is shown that the frame 5 is transferred towards a converting part 41 of a box template production system from which the box template was delivered. However, in another embodiment the frame 5 could instead be provided at the other end of the box template, right at the outlet from the box template production system and be transferred in a direction away from the box template production system.

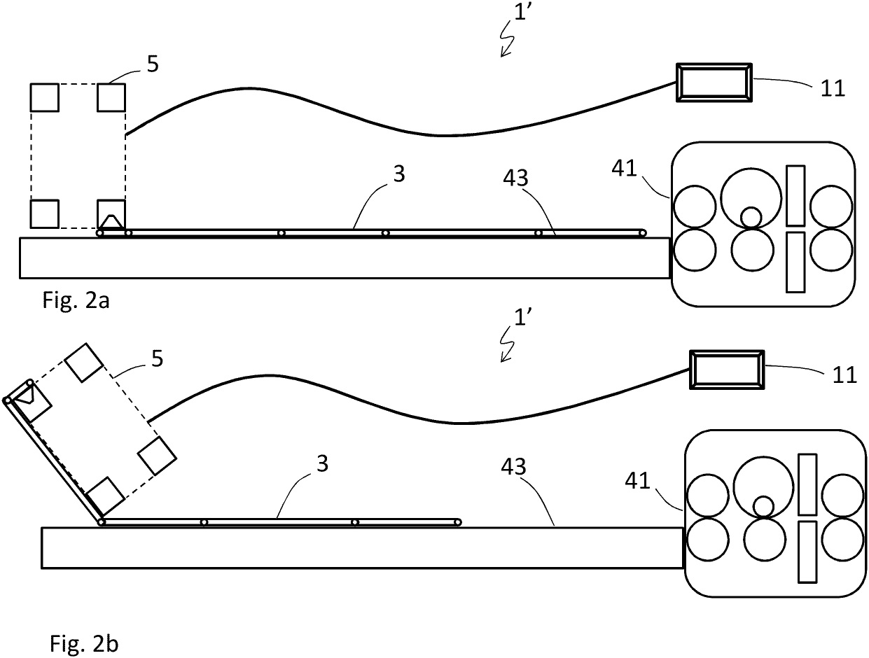

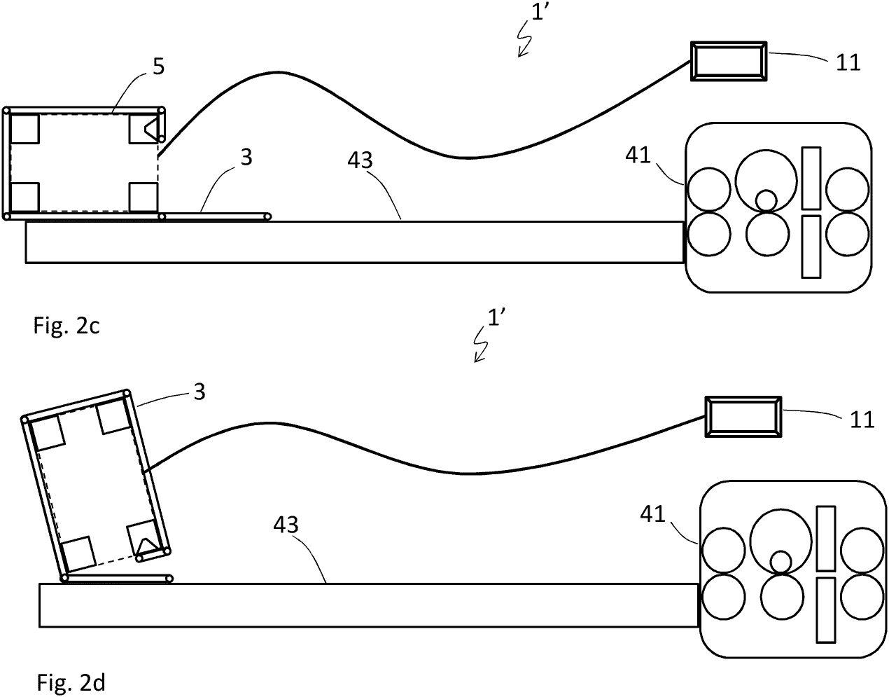

FIGS. 2a-2d show schematically a box erecting system 1′ according to another embodiment of the invention in four different positions. Most of the details are the same as in the embodiment described in relation to FIGS. 1a and 1b and are therefore given the same reference numbers and will not be described again. The only difference is that the control system 11 in this embodiment is configured for controlling the frame to only rotate and not to be transferred along a box template extension. The box template 3 is instead transferred over a surface 43 onto which it is provided. i.e., the frame 5 will pull the box template 3 over the surface 43 to wrap it around the frame 5.

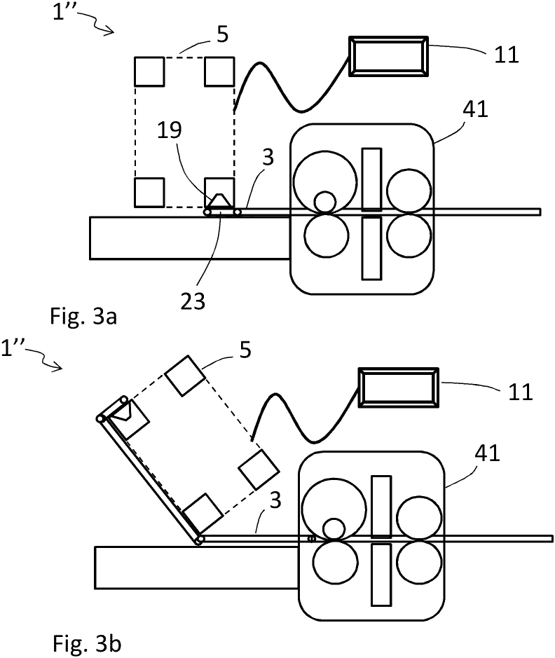

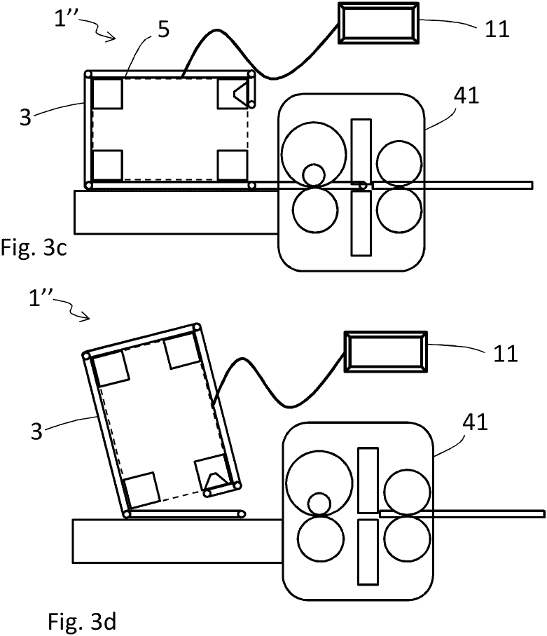

FIGS. 3a-3d show schematically a box erecting system 1″ according to still another embodiment of the invention in four different positions. In this embodiment the frame 5 is provided directly in connection with an outlet from a converting part 41 of a box template production system. Instead of delivering the box templates out from the converting part 41 onto a surface 43 as shown in the embodiments as described in relation to FIGS. 1 and 2, the box templates are in this embodiment of the invention directly wrapped around the frame 5. The control system 11 is hereby configured to first adjust the size of the frame 5 as described above. The control device 11 is further configured to control an attachment device 19 of the frame 5 to attach to a first end 23 of a box template 3 delivered from the converting part 41 and then to rotate the frame 5 such that the box template 3 is wrapped around the frame 5.

In all the embodiments described above in relation to FIGS. 1-3 a manufacturer’s joint can be sealed for example by tape or glue (possibly controlled from the control system) and possibly also a bottom of the box can be folded and possibly also sealed before the frame is removed from the erected box and used for erecting a new box. Further details and examples are given below.

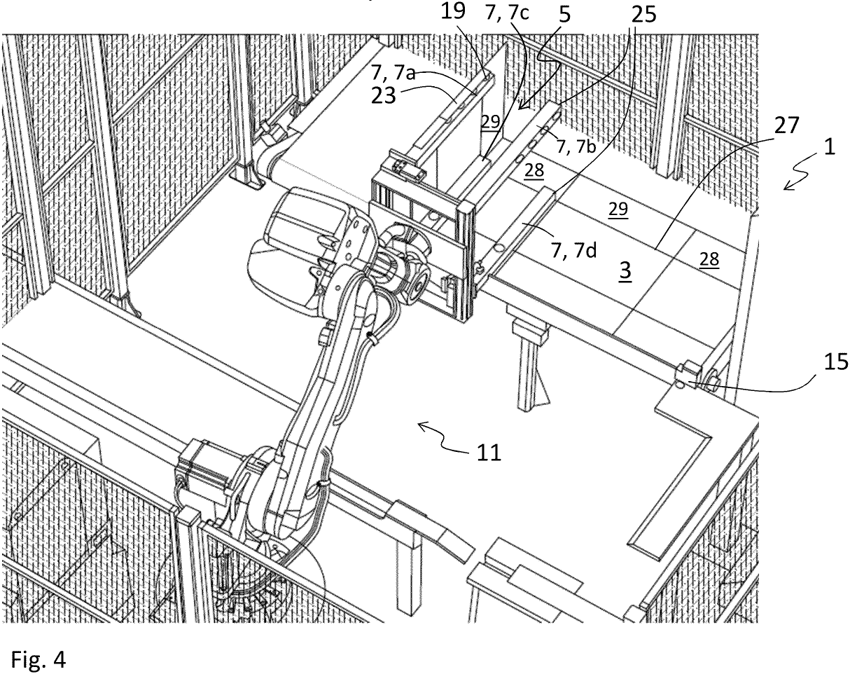

FIGS. 4-8 show a box erecting system 1 according to one embodiment of the invention in different positions. This embodiment of the invention corresponds in the principal details to the embodiment described in relation to FIGS. 1a-1d. Therefore, the same reference numbers are used for the same details and the description will not be repeated.

FIG. 4 shows the box erecting system 1 in a position where a box template 3 is about to be wrapped around a frame 5 of the box erecting system 1. The box erecting system 1 comprises a frame 5 and a control system 11 connected to said frame 5. The frame 5 comprises adjustable parts 7, which are defining the size of the frame 5 as described above. In this embodiment of the invention the frame comprises four corner posts 7a, 7b, 7c, 7d. If for example a Regular Slotted Container, RSC, or a Half Slotted Container, HSC, is erected each one of the four corner posts 7a-7d will be provided in an inside corner each of the box between two side walls of the box. Furthermore, a distance between a first one of the corner posts 7a and a second one of the corner posts 7b corresponds to a width of the finally erected box and a distance between the first corner post 7a and a third corner post 7c corresponds to a length of the finally erected box. When adjusting the size of the frame the distances between the corner posts are changed which distances correspond to the length and width of the finally erected box. Also as described above at least one of the corner posts 7 comprises an attachment device 19 to which a first end 23 of a box template 3 can be attached during wrapping of the box template around the frame 5. In the embodiment shown in FIG. 4 a first end 23 of the box template is a glue tab provided for forming part of a manufacturer’s joint. However, as described above the first end 23 does not need to be a glue tab.

Furthermore, in this embodiment it can be seen that the control system 11 is configured for providing the frame 5 to the box template 3 with a distal end 25 of the frame 5 in line with bottom flap creases 27 of the box template 3 such that a bottom can be folded while keeping the frame 5 inside the wrapped box template.

In this embodiment of the invention the control system 11 is configured for controlling the position and orientation of the frame 5 for wrapping the box template 3 around the frame 5. The control system 11 can control the attaching device 19 provided to at least one of the corner posts 7 to attach to a first end 23 of a box template 3 to be erected. The control system 11 is further in this embodiment configured to rotate the frame 5 for wrapping the box template 3 around the frame 5. In this embodiment the frame 5 is both rotated and transferred along a box template extension as described above in relation to FIGS. 1a-1d. However, in another embodiment the frame could instead be controlled only to rotate by the control system 11 while the box template instead is transferred over a surface on to which it is provided. i.e. the frame will pull the box template over the surface to wrap it around the frame (as shown in FIGS. 2a-2d).

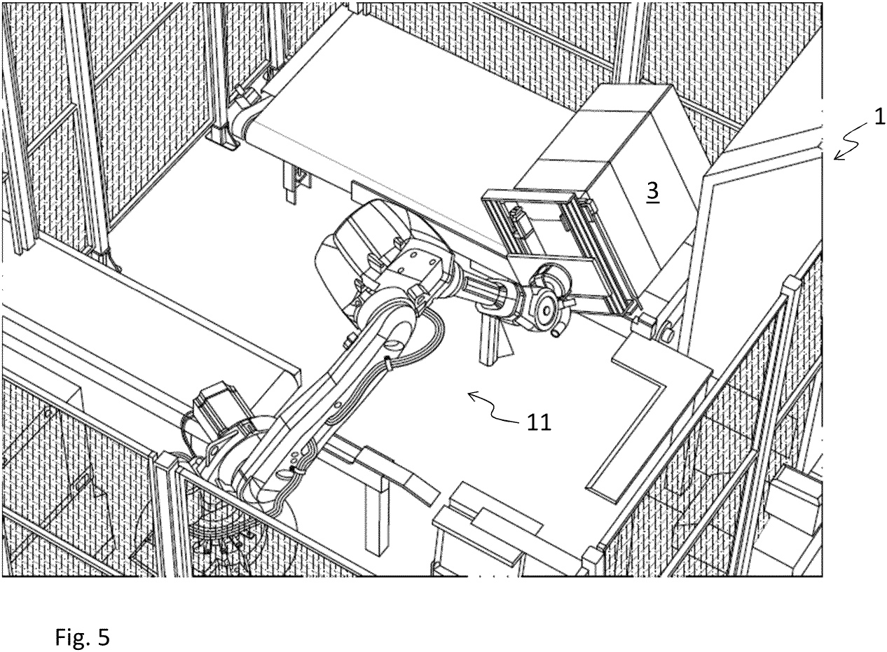

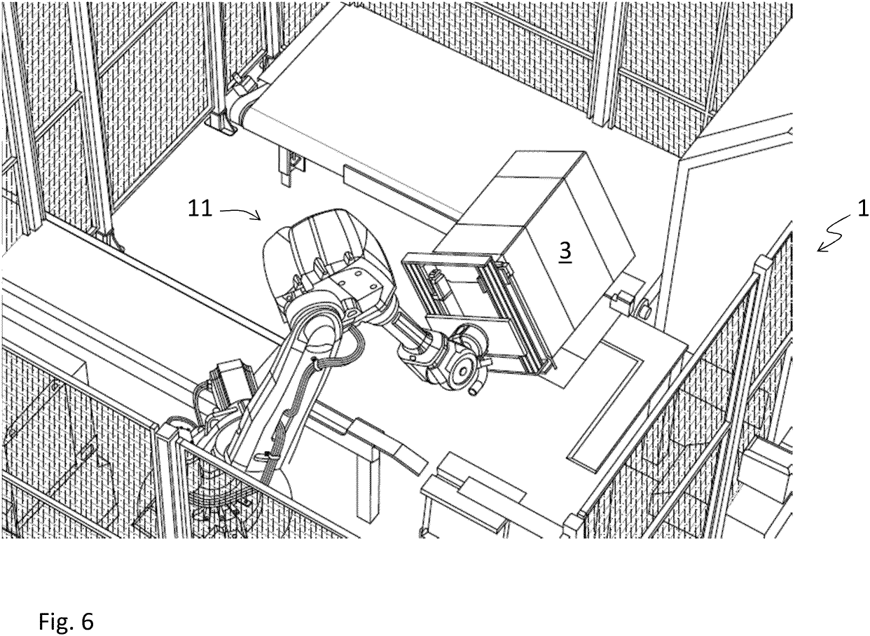

FIG. 5 shows the same box erecting system 1 as shown in FIG. 4 in a position where a box template 3 has been almost wrapped around the frame 5. In this embodiment, where a glue tab is provided as a first end 23 of the box template 3 which is attached to the attaching device 19 of the frame 5, glue is being provided to either the glue tab or a second end 24 of the box template 3 which will be mating with the glue tab 23 when the box template is completely wrapped around the frame. The sealing between the glue tab 23 and the second end 24 of the box template is referred to as the manufacturer’s joint. Hereby in this embodiment of the invention the method comprises a step of sealing a manufacturer’s joint before the frame is separated from the box template. The box erecting system comprises hereby a sealing device 15 which in this embodiment is in the form of a glue ejector 15. The glue ejector 15 is connected to the control system 11 and is controlled by the control system 11 to eject glue to the box template for sealing the manufacturer’s j oint when the box template is passing the sealing device 15. Hereby the step of sealing the manufacturer’s joint comprises in this embodiment of the invention to control the position of the frame 5 by the control system 11 such that the box template 3 is passing a sealing device 15 which will eject glue to the box template before the box template is completely wrapped around the frame. The step of sealing the manufacturer’s joint comprises providing glue to a part of the box template which will be a part of the manufacturer’s joint before the box template has been completely wrapped around the frame and thereafter complete the wrapping of the box template around the frame such that the manufacturer’s joint is sealed. The movement of the frame 5 together with the almost wrapped box template 3 such that the manufacturer’s joint passes in front of the sealing device 15 is shown in FIG. 6. Alternatively, in another embodiment of the invention the sealing device 15 (glue ejector) can be movable and be transferred along the box template for ejecting glue.

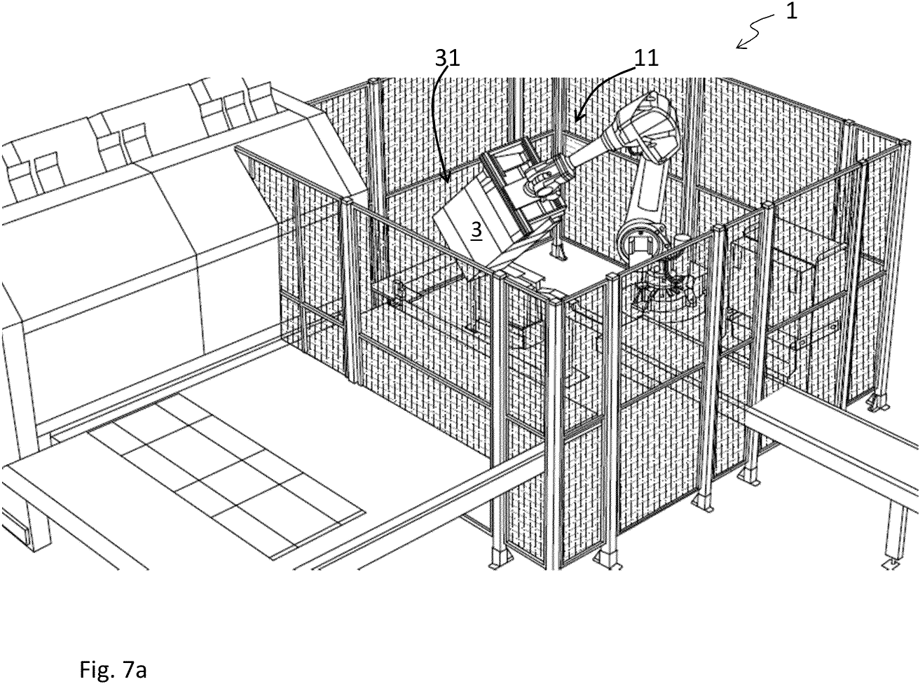

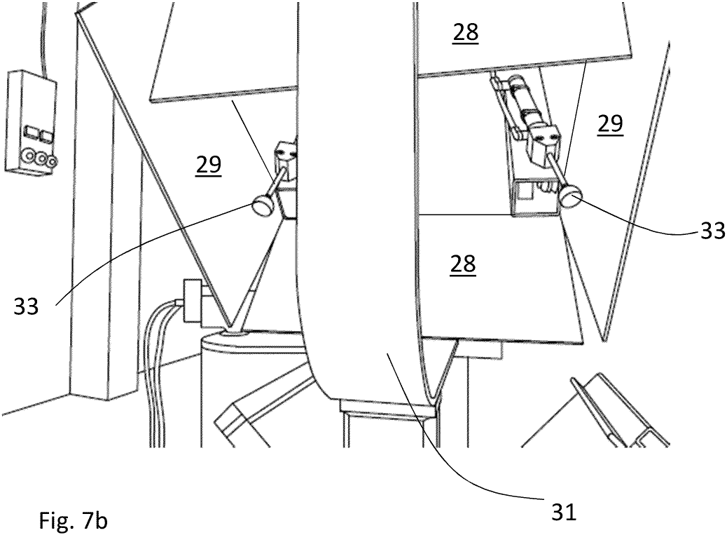

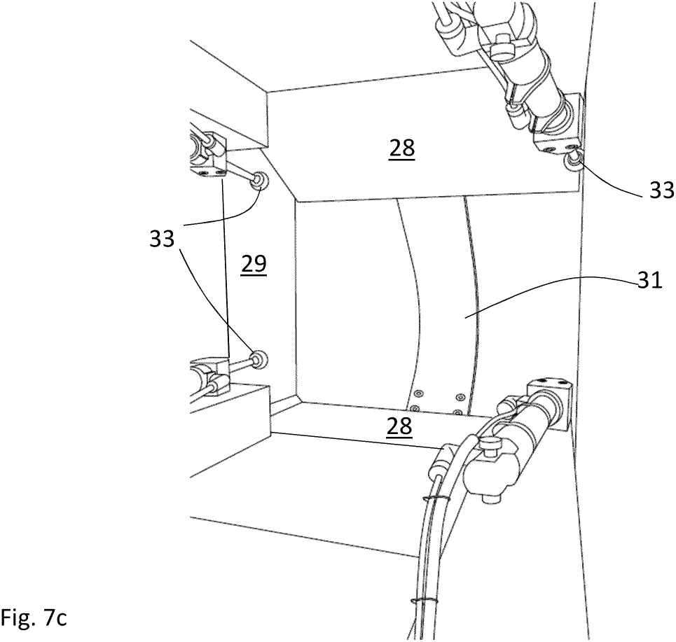

FIG. 7a shows the same box erecting system 1 as shown in FIG. 4 in a position where minor flaps of a bottom of the box template are folded. The flaps of a box forming a bottom (or a closed top) are usually referred to as minor and major flaps. However, the size of these flaps need not necessarily be minor and major in relation to each other. Hereafter the two opposing flaps which are first folded to form the bottom will be called first opposing bottom flaps 28 (usually called minor flaps) and the two remaining flaps are called second opposing bottom flaps 29 (usually called major flaps). The frame 5 holding the wrapped box template 3 is in this embodiment controlled by the control system 11 to pass a bottom folding station 31. In another embodiment of the invention the wrapped box template is delivered to a bottom folding station. In this embodiment a first part of the bottom folding station 31 is a bent rail 31 towards which the frame is pushed for folding of the first opposing bottom flaps 28. The bent configuration of the rail 31 ensures that the first opposing bottom flaps 28 are folded in a correct direction forming a bottom of the box.

FIGS. 7b and 7c show a further detail which could be added to the frame 5 in any one of the embodiments according to the invention. The box erecting system is in the same position as shown in FIG. 7a but from two other views. In this embodiment the frame 5 comprises extendable pushing arms 33 configured for pushing the two second opposing bottom flaps 29, also called major flaps, of the box template 3 outwards from each other at least during an initial part of the folding of the two first opposing bottom flaps 28, also called minor flaps, of the box template for forming a bottom of the box. Pushing the major flaps 29 outwards when the minor flaps 28 are folded is advantageous because hereby it can be avoided that the major flaps hinder the minor flaps from folding. These extendable pushing arms 33 can also be provided to all other embodiments of the invention. The use of a frame 5 and a control system 11 according to the invention for erecting boxes provides a possibility to add this function to push the major flaps outwards from each other. The extendable pushing arms 33 can be mounted to the frame 5, for example one to each corner post 7, and can be controlled by the control system 11.

The control system 11 is further configured for retracting said extendable pushing arms 33 such that they do not protrude outside the frame 5 when the major flaps (second opposing bottom flaps) 29 are to be folded for forming a bottom of the box. The major flaps can be folded by any kind of folding device (a second part of the bottom folding station 31, not shown) suitably connected to and controlled by the control system 11.

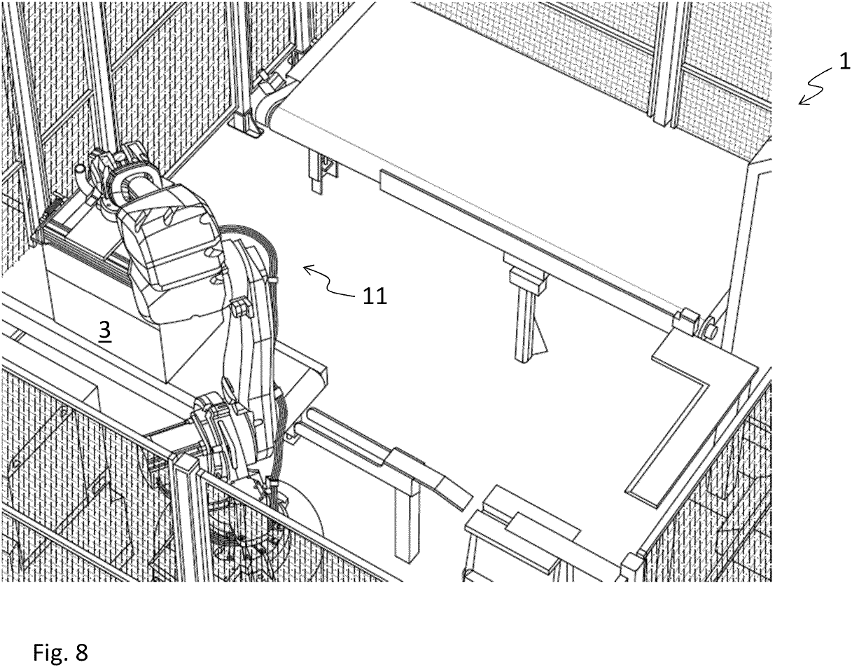

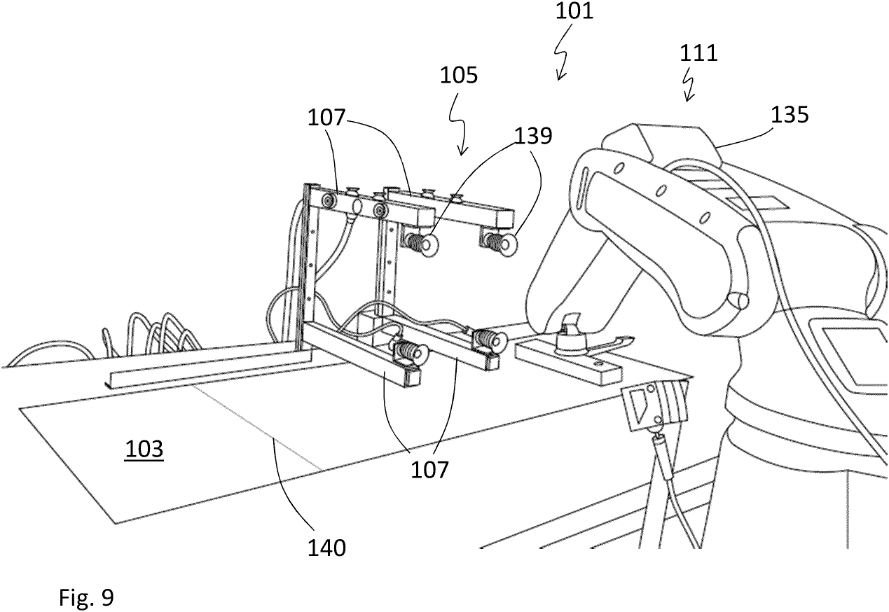

FIG. 8 shows the same box erecting system 1 as shown in FIG. 4 in a position where the whole bottom has been folded and the frame 5 is about to be removed from the erected box. The bottom can optionally be sealed by for example tape or glue before the frame is removed. The frame is then ready for erecting a new box template. If the new box template is of another size the positions of the adjustable parts 7 will be adjusted by the control system 11 according to the size of the new box template before the new box template is wrapped around the frame.

FIG. 9 shows a box erecting system 101 according to another embodiment of the invention in a position where a box template 103 is provided beneath a frame 105 of the box erecting system 101. In this embodiment of the invention the frame 105 is stationary. The frame 105 comprises also in this embodiment adjustable parts 107 defining a size of the frame. A control system 111 is connected to the frame 105 and can adjust the positions of the adjustable parts 107 such that the size of the frame can be adapted to different box template sizes. The control system 111 comprises in this embodiment at least one robot arm 135 or another suitable equipment which can be controlled to hold a box template 103 and provide the box template beneath the frame 105. In this embodiment the box template is provided by the control system beneath the frame. However, in another embodiment of the invention the box template can be provided by the control system to the frame from the top or from the side.

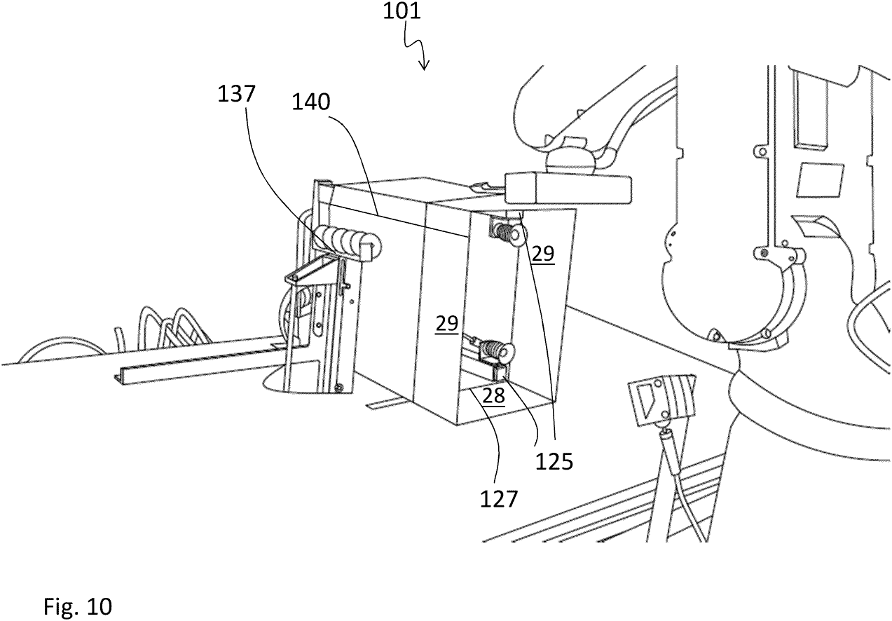

FIG. 10 shows the same box erecting system 101 as shown in FIG. 9 in a position where the box template 103 has been wrapped around the frame 105. The control system 111 comprises in this embodiment two pushing rods 137 which are controlled to protrude upwards from below the box template in order to wrap the box template around the frame 105. The robot arm 135 can then be controlled such that it folds the top part of the box template (referring to directions in the drawing) around the top part of the stationary frame 105. A manufacturer’s joint can thereafter be sealed for example by using the robot arm 135 as sealing device for providing tape or glue. Also, in this embodiment the position of the frame 105 onto the box template 103 is provided such that a distal end 125 of the frame 105 is provided in line with bottom flap creases 127 of the box template 103 such that a bottom can be folded while keeping the frame 105 inside the wrapped box template. Furthermore, also in this embodiment extendable pushing arms 33 can be provided to the frame 105 as described above in relation to the embodiment shown in FIGS. 7b and 7c. These extendable pushing arms 33 are configured for pushing two second opposing bottom flaps 29, also called major flaps, of the box template 103 outwards from each other at least during an initial part of the folding of two first opposing bottom flaps 28, also called minor flaps, of the box template for forming a bottom of the box. The bottom flaps can in this embodiment of the invention be folded by the robot arm 135. The extendable pushing arms 33 are retracted to a position inside the frame 105 before the major flaps are folded as described above. In this embodiment suction cups 139 are provided to the distal end 125 of the frame 105. These suction cups 139 will keep the minor flaps 28 folded when the robot arm 135 releases the contact with the minor flaps after having folded them towards the frame 105.

After the bottom has been folded the bottom can optionally also be sealed before the box template is separated from the frame 105. Sealing the bottom can be for example providing a tape by the robot arm.

In all the embodiments described above and illustrated in the drawings it is illustrated that the box template is provided in a horizontal direction onto a horizontal surface before wrapping around the frame. However, it is not necessary to provide the box template onto a horizontal surface before the step of wrapping it around the frame. The box template could be provided in any angle possibly onto a surface having any suitable angle. The box template could also be hanging in a vertical direction when the box template is wrapped around the frame. One end of the box template could be attached to something and the box template could be hanging from this attachment point. Possibly the box template could be hanging out from a box template production system. The frame could then be controlled by the control system to wrap the box template around the frame in the same way as described above. Yet another example of alternative orientation of the box template is that the box template can be tilted on its side to any angle during the wrapping around the frame. Furthermore, the box template need not be provided straight or planar during the wrapping procedure around the frame.

According to another aspect of the invention a method for producing boxes from sheet material is provided. The sheet material can be for example cardboard or corrugated board. The method comprises the steps of:
producing box templates of different sizes from sheet material;
erecting the box templates according to any one of the embodiments of the methods for erecting boxes as described above.

The method can further comprise an initial step of providing the sheet material to a box template production system from bales of fanfolded sheet material. When the box templates are produced from fanfolded material, such as for example fanfolded corrugated board, folds will be provided in the box templates also at other positions than intended, here called fanfold folds. These fanfold folds can be problematic to handle when erecting the boxes because the box walls may not behave as walls without such fanfold folds. They may fold along a fanfold fold rather than along intended crease lines. Ensuring corner folding in intended positions is crucial to ensure the further process steps, for example bottom flap folding. The use of the frame and the method of wrapping the box templates around the frame for erecting the boxes will be especially suitable for and improve erection processes of box templates comprising fanfold folds, i.e., box templates provided in different sizes on demand from fanfolded sheet material. Such a fanfold fold 140 is shown in the box template 103 which is erected by the box erecting system 101 shown in FIGS. 9 and 10. Here it is apparent that the corner posts 107 of the frame 105 are useful for avoiding folding of the upper part of the box wrongly along the fanfold fold 140 instead of along the correct fold. Hereby the bottom can be closed correctly in a reliable process. The sheet material could also be provided to the box template production system from corrugated rolls. Corrugated board provided in rolls can for example be single phase corrugated board. The use of the frame and the method of wrapping the box templates around the frame for erecting the boxes will be advantageous also when using sheet material provided from such rolls.

According to another aspect of the invention a box production system is provided comprising:
at least one inlet for receiving sheet material;
at least one converter part 41 configured for receiving said sheet material and convert said sheet material into box templates of different sizes according to given instructions;
at least one box erecting system 1; 101 according to any one of the embodiments described above configured for erecting box templates provided from the at least one converter part 41.

In one embodiment of the invention said at least one inlet is configured for receiving said sheet material from bales of fanfolded sheet material as described above. The control system 11; 111 of the box erecting system comprises further a processor and a computer program which when run on the processor causes the control system to perform the method for erecting boxes as described above.

The invention comprises further a computer program comprising computer readable code which, when run on a processor in a control system 11; 111 of a box erecting system according to the invention causes the control system to perform the box erecting method of the invention as described above.

1. A box erecting system for erecting a box from a box template, the box erecting system comprising:
a frame comprising adjustable parts, distances between the adjustable parts being adjustable to vary dimensions of the frame to correspond to dimensions of a box being formed, the frame being rotatable to enable wrapping of a box template therearound to form a box;
an attaching device connected to at least one of the adjustable parts of the frame and configured for attaching the frame to a box template that is to be erected into a box; and
a bottom folding station configured to fold two first bottom flaps a box template while the box template is wrapped around the frame, the two first bottom flaps being configured to form a portion of a bottom of the box when it is erected, the two first bottom flaps opposing each other when the box is erected.

2. A box erecting system according to claim 1, further comprising a control system connected to the frame and configured for:
rotating the frame for wrapping a box template attached to the frame around the frame;
adjusting the size of the frame by adjusting the distances between the adjustable parts; or
moving the frame with the box template wrapped therearound to the bottom folding station.

3. A box erecting system according to claim 1, further comprising a gluing device arranged in the box erecting system for applying glue to one or more parts of a box template.

4. A box erecting system according to claim 1, wherein the bottom folding station comprises a bent rail configured to have the two first bottom flaps pushed thereagainst to fold the two first bottom flaps.

5. A box erecting system according to claim 1, wherein the bottom folding station comprises one or more extendable push arms configured to push one or more second bottom flaps in an outward direction.

6. A box erecting system according to claim 5, wherein the one or more extendable push arms comprise two extendable push arms, the one or more second bottom flaps comprise two second bottom flaps that are opposite to one another, and the two extendable push arms are configured to push the two second bottom flaps away from one another.

7. A box erecting system according to claim 1, wherein the frame is configured to be provided to the box template with a distal end of the frame substantially in line with bottom flap creases of the box template such that a bottom can be folded while keeping the frame inside the wrapped box template.

8. A method for erecting a box from a box template, said method comprising:
adjusting a size of a frame according to a size of the box template that is to be erected into a box;
folding two first bottom flaps and two second bottom flaps of the box template, the first and second bottom flaps being configured to form a bottom of the box when erected and the two first bottom flaps opposing each other and the two second bottom flaps opposing each other when the box is erected;
attaching the box template to the frame; and
rotating the frame to wrap the box template around the frame.

9. A method according to claim 8, wherein adjusting the size of the frame comprises adjusting distances between four corner posts of the frame.

10. A method according to claim 8, wherein folding the two first bottom flaps and the two second bottom flaps comprises folding the two first bottom flaps a first amount and folding the two second bottom flaps a second amount that is different than the first amount.

11. A method according to claims 8, wherein folding first and second bottom flaps of the box template comprises advancing the box template towards the frame such that a first guiding device provided in the feeding part will force the first and second bottom flaps to fold between 60 and 90 degrees in relation to an adjacent side wall part of the box template.

12. A method according to claim 8, further comprising folding two first top flaps and two second top flaps of the box template, the first and second top flaps being configured to form a top of the box when it is erected and closed and the two first top flaps are opposing each other and the two second top flaps are opposing each other in the box when it is erected, wherein the first and second top flaps are folded in relation to an adjacent side wall part of the box template and in an opposite direction compared to the folding of the bottom flaps.

13. A method according to claim 8, further comprising sealing a manufacturer’s joint and a bottom of the box before the erected box is separated from the frame.

14. A method according to claim 13, wherein sealing a manufacturer’s joint and a bottom of the box comprises providing glue to a first end or a second end of the box template and to the first or the second bottom flaps before the box template has been completely wrapped around the frame and compressing the manufacturer’s joint and compressing the first bottom flaps towards the second bottom flaps to seal the bottom.

15. A method for erecting a box from a box template, said method comprising:
adjusting a size of a frame according to a size of the box template that is to be erected into a box;
attaching the box template to the frame;
rotating the frame to wrap the box template around the frame;
moving the frame with the box template wrapped therearound to a bottom folding station; and
folding one or more first bottom flaps of the box template to a closed position.

16. A method according to claim 15, wherein folding one or more first bottom flaps of the box template to a closed position comprises pressing one or more of the first bottom flaps against a bent rail.

17. A method according to claims 15, further comprising folding one or more second bottom flaps of the box template in an outward direction.

18. A method according to claim 15, further comprising folding two first top flaps and two second top flaps of the box template, the first and second top flaps being configured to form a top of the box when it is erected and closed and the two first top flaps are opposing each other and the two second top flaps are opposing each other in the box when it is erected, wherein the first and second top flaps are folded in relation to an adjacent side wall part of the box template and in an opposite direction compared to the folding of the bottom flaps.

19. A method according to claim 15, further comprising sealing a manufacturer’s joint and a bottom of the box before the erected box is separated from the frame.

20. A method according to claim 19, wherein sealing a manufacturer’s joint and a bottom of the box comprises providing glue to a first end or a second end of the box template and to the first or the second bottom flaps before the box template has been completely wrapped around the frame and compressing the manufacturer’s joint and compressing the first bottom flaps towards the second bottom flaps to seal the bottom.
